(19) United States
(12) Patent Application Publication
(10) Pub. No.: US 2002/0075398 A1
(43) Pub. Date: Jun. 20, 2002

(54) Method and apparatus for upgrading optical imaging systems to accommodate replacement cameras

(76) Inventors: William Milam JR., Yucaipa, CA (US); Robert Hodson, Norwalk, CA (US); Don Newton, Redondo Beach, CA (US)

Correspondence Address: Jack I J'maev, 12616 Lewis Ave, Chino, CA, 91710, US

(21) Appl. No.: 10/023,498

(22) Filed: Dec. 17, 2001

Related U.S. Application Data
(60) Provisional application No. 60/256,684, filed on Dec. 18, 2000.

(51) Int. Cl. H04N 5/225; H04N 5/222; H04N 7/18

(52) U.S. Cl. 348/374; 348/376; 348/64; 348/333.09; 396/429

(57) ABSTRACT

A method and hardware kit to upgrade application-specific optical instruments. The upgrade facilitates replacement of the photographic element normally supplied by the manufacturer of an optical instrument with a commercially available camera.

### RELATED APPLICATIONS

This present application is related to a provisional application serial No. 60/256,684 filed on Dec. 18, 2000, entitled “DIGITAL CAPTURE UPGRADE APPARATUS AND METHOD FOR IMAGING EQUIPMENT” invented by William Milam, Jr. et al., currently pending, for which the priority date for this application is hereby claimed.

### BACKGROUND OF THE INVENTION

1. Technical Field

This invention pertains to the field of imaging equipment. Specifically, this invention pertains to methods and apparatus supporting the upgrade of imaging systems to allow use of a replacement camera.

2. Description of the Prior Art

Many and varied imaging systems are currently known. Most of these systems include sophisticated optical assemblages, each tailored to meet the functional requirements of a particular use. Many industries and professions use specialized imaging systems. One such profession is the medical profession. Medical imaging systems have generally been integrated with specialized photographic equipment that are tailored to meet the specialized needs of particular applications. The specialized photographic equipment rarely conformed to any standards otherwise promulgated in consumer or industrial applications. This rendered the entire medical imaging apparatus, comprised of an optical assemblage and a photographic element, to be entirely unique. This, of course, results in the need for specialized logistical support for the apparatus. When any particular component failed, only the original manufacturer would likely be capable of supplying replacement parts.

The photographic element used in known medical imaging systems is the one component most susceptible to failure. Generally, the photographic element in a medical imaging system comprises a camera. The cameras used by each manufacturer are usually specific to the imaging systems they build and do not conform to industry standards. One purpose for this lack of conformity is simply a financial motive on the part of imaging system manufacturers. By using custom cameras, imaging system manufacturers can force their customers to return for service, repair or replacement of the application specific camera. A second purpose for the use of custom cameras was in fact, functional. In many cases, the optical assemblages used to collect and process application specific images required extended or irregular exposure means.

The cost incurred in purchasing a specialized imaging system has always been significant, due mostly to the custom nature of the equipment and the limited number of units produced. And only a few customers demand such high-priced equipment. Hence, the demand for specialized imaging systems is extremely limited. The combination of limited demand and high price has limited the number of manufacturers, resulting in an oligopoly.

The oligopolistic nature of the specialized imaging system marketplace has left the industry in a state where new innovations are slow to develop and are typically extremely expensive. As one example, consider a typical medical imaging system. The prior art film based apparatus have been displaced by new digital imaging systems. However, the new digital imaging systems have been slow to market and are again proprietary in nature. In medical imaging systems, manufacturers have again failed to adopt industry norms in order to force system users to return to the original manufacturer, or its authorized agents for repair and/or service.

One even more discouraging manifestation of the prior art digital imaging systems is that the manufacturers that comprise the oligopoly have chosen to implement video based digital capture. This format, although easy to integrate into existing optical assemblages, fails to provide the resolution previously attainable by earlier film based cameras. Hence, the peculiar nature of the specialized imaging systems marketplace has caused a depreciating quality in the overall product.

These factors have left institutions, which are the most prevalent users of medical imaging instruments, in somewhat of a quandary. The motive to update to a digital imaging system is clearly present in the industry, but to do so required high capital investment. And adding insult to injury, the resolution offered by the video based systems is far inferior to that obtainable with the film based imaging systems currently in use. In many case, medical imaging system users cannot justify the expense of upgrading to a digital solution, especially in light of inferior photographic resolution. As a result, the existing legacy systems continue in service. Of course, this same result is found in other specialized imaging systems that are used in various industries.

What is needed then, is a means to upgrade specialized imaging instruments so that replacement film cameras or digital cameras may be used. Where digital cameras are used, digital images should be captured with high resolution. From the financial perspective any such means should take advantage of any legacy equipment that users are currently operating. The present invention addresses both of these issues by providing a method of adapting a modern film or digital camera to a legacy optical assemblage used in specialized imaging systems.

### SUMMARY OF THE INVENTION

Of particular importance is the need to replace original cameras supplied by the original manufacturers of optical imaging systems. Keeping in mind that many of these original cameras are inferior to those commercially available to the general public, the present invention comprises an upgraded method and hardware kit that facilitates the use of replacement cameras in these application specific imaging systems.

These application specific imaging systems typically comprise an attachment means that couples the originally supplied camera to an optical assemblage; these elements taken together comprise the imaging system. In one example method according to the present invention, upgrading an imaging system comprises a first step of removing the attachment means from the optical assemblage. After the attachment means is removed, a new attachment means may be installed on the optical assemblage.

In one example embodiment of this method, the new attachment means comprises a quick-release receptacle. Such a quick-release receptacle may comprise an offset-eliminating flange or a non-offset-eliminating flange together with a capture cowling. In some embodiments of a method according to the present invention, use of an offset-eliminating flange may be desirable when the optical instrument comprises a parametric data generator. In some situations, the information created by the parametric data generator may not be needed in an upgraded instrument. Hence any offset introduced by the original optical assemblage to accommodate parametric data may need to be eliminated by said offset-eliminating flange. In those situations where no offset needs to be eliminated, the method provides for use of a non-offset-eliminating flange. The capture cowling engages with the flange in order to retain a camera adapter coupling.

In one illustrative example, the method of the present invention relies on the use of a camera adapter coupling. In one method described by the invention, the camera adapter coupling may comprise a quick-release coupling end and a lens-emulating flange end that opposes the quick-release coupling end. The method provides for attachment of a replacement camera by first coupling the camera, which comprises a lens mount, to the lens-emulating flange comprising the camera adapter coupling. The camera adapter coupling may then be mated with the quick-release receptacle installed on the optical assemblage. In many instances, the method of the present invention provides for use of a digital camera. This enables legacy optical imaging systems to be upgraded with a digital imaging capability.

The method of the present invention may further comprise insertion of a compensating lens into the optical path of an imaging instrument. Use of is such a compensating lens may be required if the original image focused by the optical instrument into the originally supplied camera may be enlarged. Enlargement of the original focused image may be desirable where the replacement camera provides a higher resolution or image clarity vis-à-vis the original camera. Use of a compensating lens may also be required to adjust the focal length of the optical assemblage so as to ensure that the image is properly focused in the replacement camera.

In some embodiments of the method described herein, the camera adapter coupling may be adjusted in length so as to enlarge the image focused into the replacement camera, or to ensure that the image is properly focused in the replacement camera, or both. In some alternative embodiments of the method of the present invention, additional steps may be taken to displace an eyepiece that may comprise the optical imaging system undergoing upgrade. In some situations, the eyepiece, which is used to the aim the optical path of the instrument, may cause a mechanical interference with a replacement camera. In these situations, the method of the present invention may be augmented with a step for displacing the eyepiece to prevent such interference.

The invention further comprises an upgrade kit that facilitates replacement of the original cameras used in application specific imaging systems. Such an upgrade kit may comprise a quick-release receptacle that may be mounted on the optical assemblage of an imaging system. The upgrade kit may further comprises a camera adapter coupling that may be affixed to a replacement camera comprising a lens-emulating flange on one side and a quick-release coupling on the other. In use, the camera adapter coupling is installed on to a replacement camera by inserting the lens-emulating flange into a lens mount that comprises the replacement camera. The quick-release end of the camera adapter coupling may then be mated with the quick-release receptacle mounted on the optical assemblage in order to mount the replacement camera thereon.

The upgrade kit, according to one alternative embodiment of the present invention, may further comprise a camera. In some embodiments of the upgrade kit, the camera may be a digital camera. In another alternative embodiment of this invention, the upgrade kit may further comprise a compensating lens. Where a compensating lens is included, it is selected to adjust the focal length of the optical assemblage to ensure proper image focusing into the replacement camera. Selection of the compensating lens may also reflect the desire to enlarge images received from the optical assemblage as they are focused into the replacement camera.

In some embodiments of the upgrade kit, the length of the camera adapter coupling may be adjusted to ensure that the image received from the optical assemblage is properly focused into the replacement camera. The length of the camera adapter may also be adjusted in order to enlarge the image that ultimately reaches the replacement camera.

In yet another alternative embodiment of the upgrade kit, an eyepiece tower may be provided. The eyepiece tower serves to displace an eyepiece, which may comprise the optical imaging system, in those situations where the eyepiece may mechanically interfere with the installation of a replacement camera.

### BRIEF DESCRIPTION OF THE DRAWINGS

The foregoing features, aspects, and advantages of the present invention will become better understood from the following detailed description of one embodiment of the invention with reference to the drawings, in which:

FIG. 1 is a pictorial representation of a typical application specific imaging system;

FIG. 2 is a pictorial representation of a typical application specific imaging system that has been upgraded to further comprise a digital capture camera;

FIG. 3 is a schematic pictorial of one example of the internal composition of a known optical assemblage;

FIG. 4 is a schematic pictorial of one example of an upgraded imaging system;

FIG. 5A is a pictorial representation of the offset included in prior art imaging systems;

FIG. 5B is a pictorial representation of the enhanced resolution obtained by eliminating the offset needed to accommodate parametric data;

FIGS. 6A and 6B are pictorial representations of one example of an offset mounting flange and an offset-eliminating mounting flange, respectively;

FIGS. 7A through 7D are pictorial representations of one example of an offset-eliminating mounting flange;

FIGS. 8A through 8C are pictorial representations of one example embodiment of a digital camera adapter coupling; and

FIG. 9 is a pictorial diagram that depicts the one possible arrangement of the hardware elements of an upgrade kit according to the present invention.

### DETAILED DESCRIPTION OF THE INVENTION

The present invention is best described by application of the method and apparatus to a specific medical imaging system. It should be noted, however, that the descriptions proffered here are only a convenient means of describing the invention and are not intended to limit the scope thereof.

One type of an imaging instrument that may be upgraded to accommodate a replacement camera by the method and apparatus of the present invention is a fundus camera used in ophthalmology. Again, this is merely an example of one type of imaging system and the teachings proffered here are not intended to limit the scope of the present invention. The present invention is applicable to any type of imaging system irrespective of industry or profession or application.

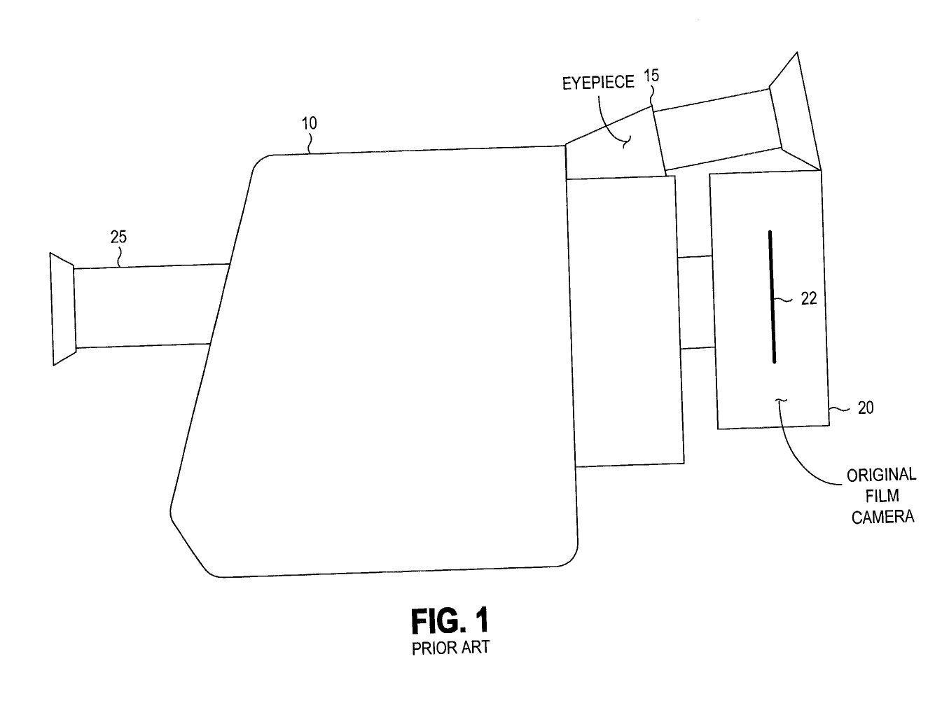

FIG. 1 is a pictorial representation of a typical application specific imaging system. The imaging system itself comprises an optical assemblage 10, an eyepiece 15 and a film capture camera 20. In the prior art, an operative lens 25 receives an image from the subject matter and by way of the optical assemblage 10 propagates the image to a film capture camera 20. The image is focused onto a film image plane 22 located within the cavity of the film camera.

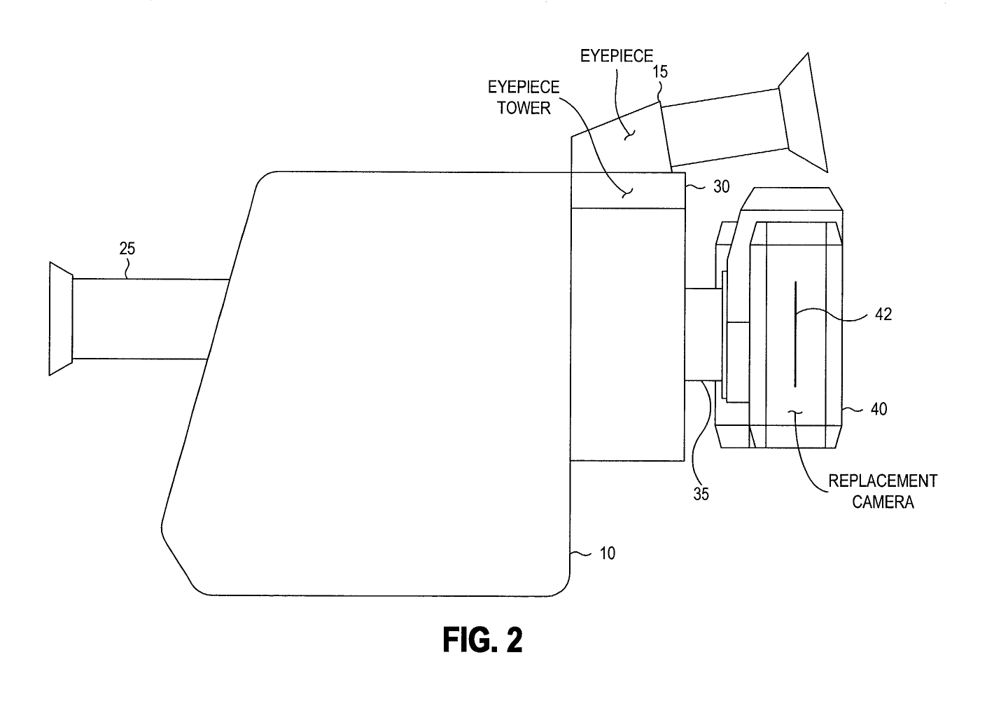

FIG. 2 is a pictorial representation of a typical application specific imaging system that has been upgraded to further comprise a replacement camera. In the preferred embodiment of an upgraded imaging system, the operative lens 25 remains unmodified. The eyepiece 15 is also unmodified, but may require relocation by means of an eyepiece tower 30. A new coupling means 35 is affixed to the optical assemblage 10. This enables the attachment of a replacement camera 40. The captured image is directed to a replacement camera having a sensitive surface at a replacement image plane 42 located within the cavity of the replacement camera 40. It should also be noted that the present invention may also be used with a digital camera. Such cameras may be generally available to the consuming public or to professionals in the photographic industry.

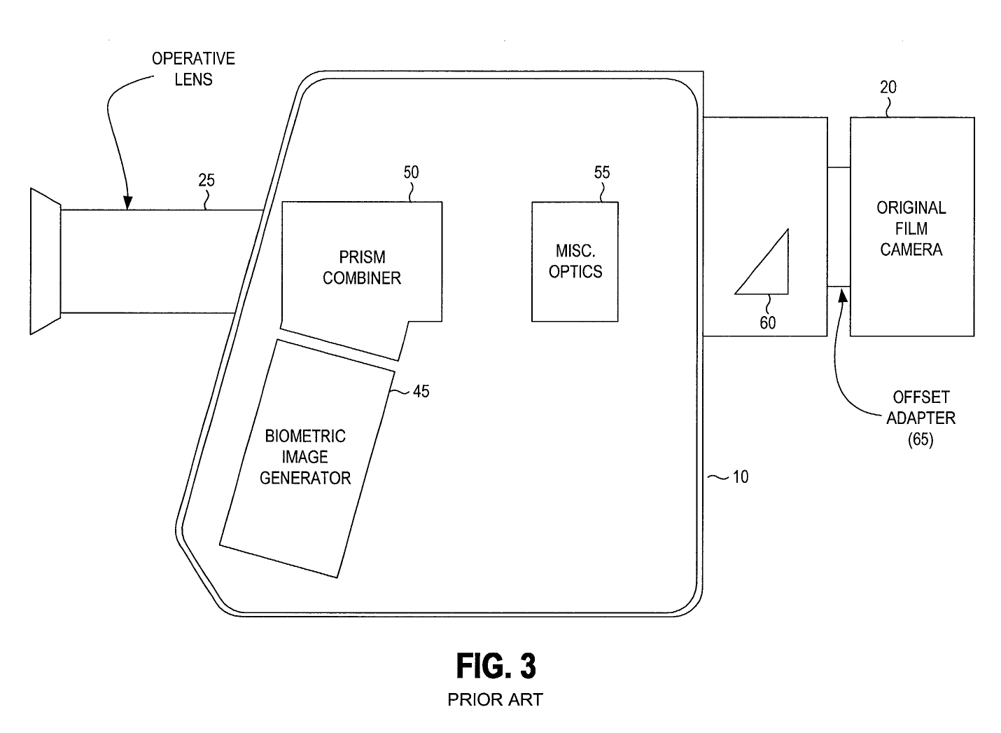

FIG. 3 is a schematic pictorial of one example of the internal composition of a known optical assemblage. As already discussed, the operative lens 25 collects an image from a subject. That image may be combined with the output of a parametric data image generator 45 by an optical prism combiner 50. Miscellaneous optics 55 complete the optical path internal to the optical assemblage 10. The purpose of these miscellaneous optics can be as varied as the specific application that any given imaging system is tailored to. The structure of the miscellaneous optics is not important in the scheme of the present invention so long as their optical transfer function may be determined.

In this example, a second prism 60 may be present in the rear of the optical assemblage 10. This second prism directs a portion of the light energy to an eyepiece and the remainder may be directed to a film camera 20. In the prior art, a film camera was usually affixed to the optical assemblage using an offset adapter 65. The offset adapter 65 may be used to relocate the center of the subject image away from the center of the film, but a non-offset adapter may have been equally employed.

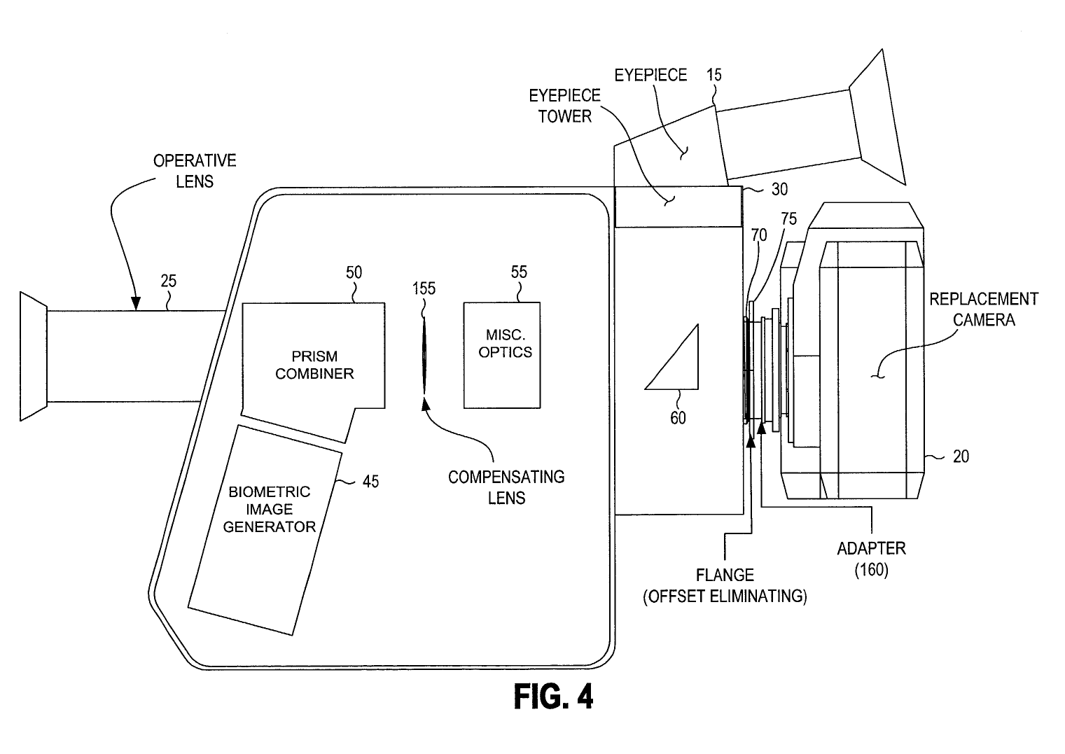

FIG. 4 is a schematic pictorial of one example of an upgraded imaging system. The present invention comprises a method of upgrading an application specific imaging system. The present invention further comprises an apparatus that supports the upgrade of an application specific imaging system to accommodate a replacement film or digital camera.

In order to upgrade an imaging system, the transfer function of the optical path must be ascertained. The optical path is ordinarily described using well-known techniques. This first step of ascertaining the optical path itself comprises two steps, those being the step of measuring the optical transfer functions of the components found in the path and then documenting the optical path based on the measured transfer functions. In one illustrative example, the transfer functions for each of the optical components, i.e. the operative lens 25, the prism combiner 50, the miscellaneous optics 55 and the optional eyepiece prism 60, are obtained by way of measurement. As an alternative means to measurement, the original manufacturer of the imaging system may provide details of these transfer functions upon query or they may be found in a repair manual, design specification or the like.

One step in upgrading an instrument is that of removing an attachment adapter 65 from the optical assemblage 10. Once the camera attachment means is removed, detailed measurements of the mounting structure integral to the optical assemblage are obtained through measurement. As an alternative to measuring the mounting structure, the original manufacturer of the imaging system may provide these details upon query, or they may be found in a repair manual, design specification or the like.

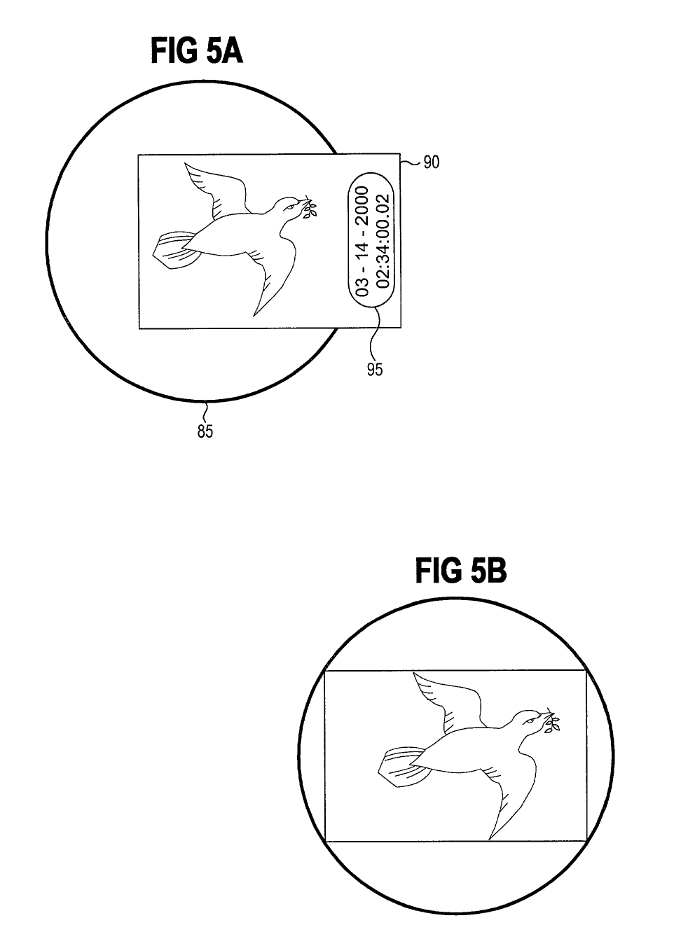

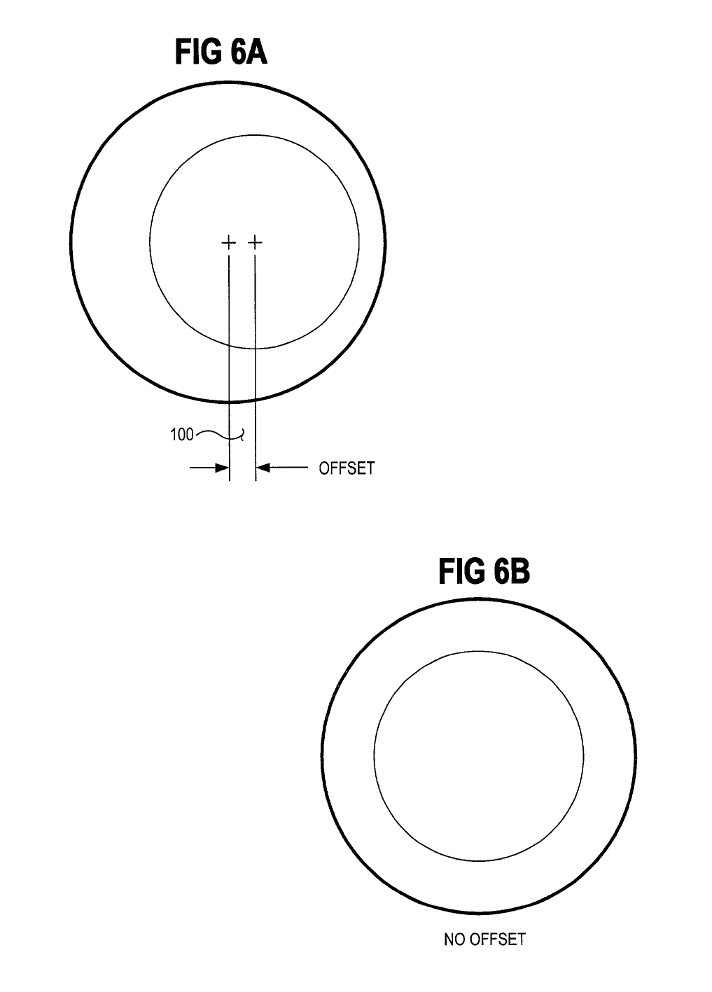

FIG. 5A is a pictorial representation of the offset included in prior art imaging systems. In prior art imaging systems, a parametric image generator 45 creates an optical representation of the date and time that an image is captured together with other useful information. In order to accommodate the optical image representing the parametric data, the subject matter 80, ordinarily located in the center of the optical path is shifted away from the center of the film frame 90. By so offsetting the subject matter 80, parametric data 95 can be included on the film frame 90.

FIG. 5B is a pictorial representation of the enhanced resolution obtained by eliminating the offset needed to accommodate parametric data. In FIG. 5B, it is apparent that the subject matter 80 is now focused onto the center of the film frame 90. What is less apparent from this figure is that the subject matter may be enlarged in order to take advantage of the larger film area; thereby improving the resolution of the captured image.

Another step in upgrading an imaging instrument to accommodate a replacement camera is the step of attaching a quick-release receptacle to optical assemblage 10. The quick-release receptacle may be designed so that it is compatible with the mounting structure integral to the optical assemblage. In the present embodiment, a quick release mechanism comprises an offset eliminating flange 70 and a capture cowling 75.

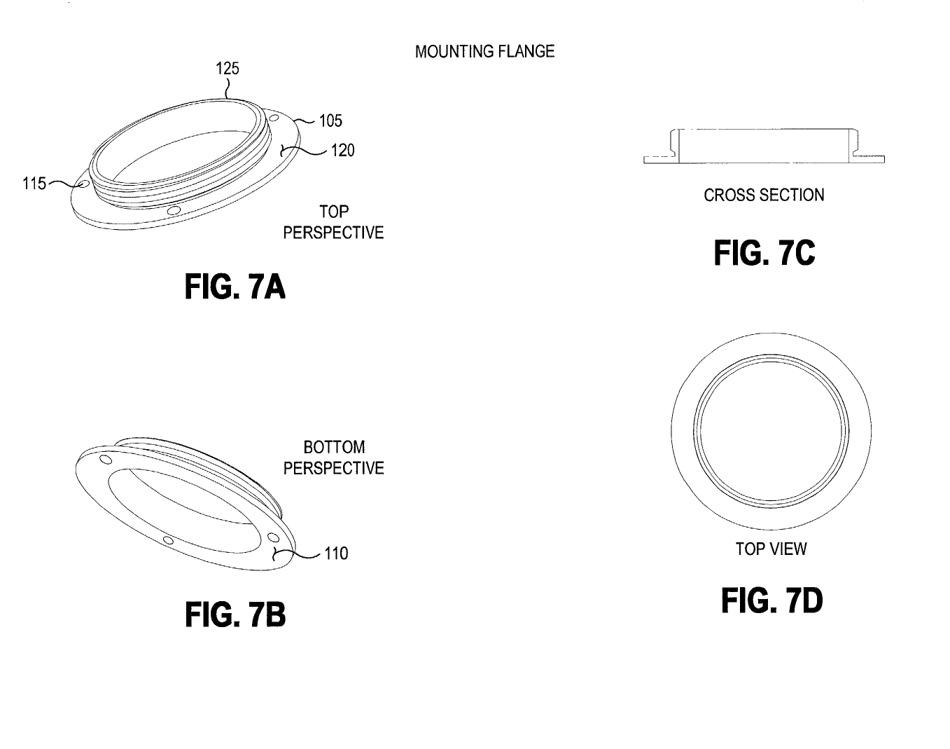

FIGS. 6A and 6B are pictorial representations of one example of an offset mounting flange and an offset-eliminating mounting flange, respectively. Many imaging systems that incorporate parametric image generators 45 include a camera-mounting flange that includes an offset 100. The present invention comprises a mounting flange that eliminates this offset for the reasons set forth above. The present invention may also comprise a non-offset-eliminating flange for use in situation where no offset needs to be eliminated.

In one illustrative example, the offset-eliminating flange 70 comprises a quick release coupling that happens to be concentric with the mounting flange. It should be noted that in other embodiments, the actual implementation may include a physical offset. This physical offset is not to be confused with the functional offset. The functional offset, i.e. that offset that is imparted to the image of the subject matter relative to the film frame, is substantially eliminated in the present invention.

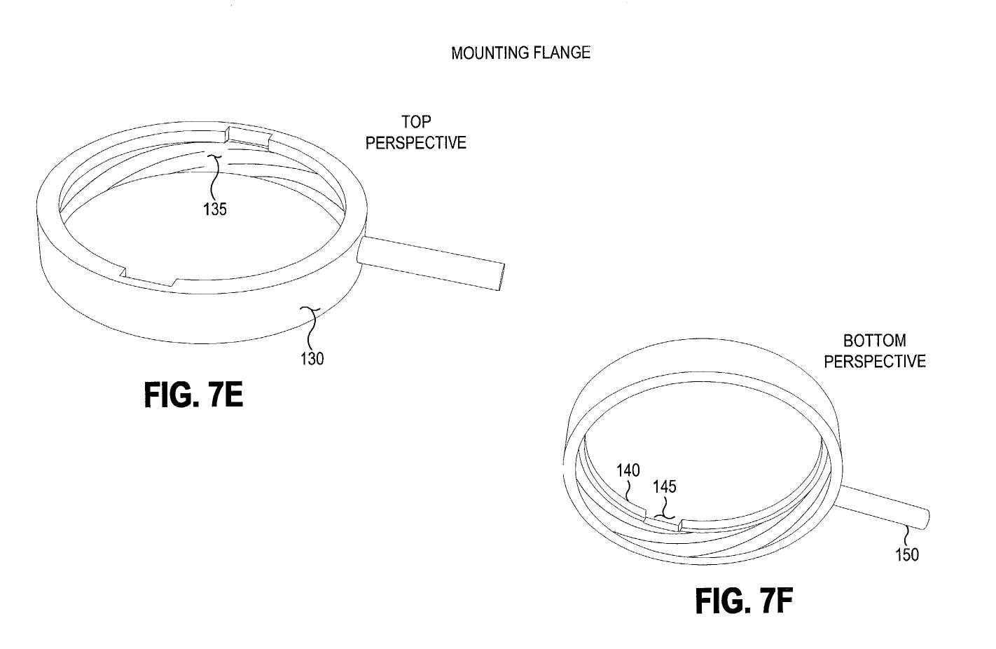

FIGS. 7A through 7D are pictorial representations of one example of an offset-eliminating mounting flange. The offset-eliminating mounting flange comprises one element of the apparatus used to upgrade an imaging system to provide for use of a replacement camera. The offset-eliminating flange 70 comprises a donut shaped disk 105 having a first face 110 that abuts the optical assemblage 10 and comprises a plurality of mounting holes 115 that correspond to mounting holes in the camera mounting structure integral to the optical assemblage 10. The donut shaped disk further comprises a second face 120 opposite the first face. The offset-eliminating flange 70 may further comprise a threaded diameter 125 that protrudes outward and away from said second face of the donut shaped disk. These attributes may be varied to accommodate various mounting requirements for any given optical assemblage 10 and replacement camera 40.

FIGS. 7E and 7D are pictorial representations of one example embodiment of a capture cowling. The capture cowling 75 comprises a ring shaped part comprising an outer diameter 130 and a threaded inner diameter 135. The capture cowling 75 further comprises a lip 140 at one end of the ring. Said lip comprises a plurality of discontinuities 145 that correspond to splines integral to a camera adapter. The capture cowling may optionally comprise a lever 150 that is used to rotate the cowling 75 when it is screwed onto the threaded diameter 125 of the offset eliminating mounting flange 70.

Upgrading an imaging instrument so as to accommodate a replacement camera may require the step of displacing an eyepiece tower. As can be seen in FIG. 4, the overall size of the replacement camera 40 that is to be coupled to the optical assemblage 10 must be considered to ensure that the eyepiece 15 originally included with the imaging instrument is not obstructed. In order to do this, the eyepiece 15 may be displaced by some distance in order to prevent interference with the replacement camera body. Of course, the eyepiece of some imaging instruments may not be obstructed by the size of the replacement camera 40.

Even where a particular instrument does not require relocation of the eyepiece, i.e. the size of the replacement camera 40 is commensurate with the film camera 20 used in the original application, the eyepiece may still need to be relocated. The minimum amount of relocation that the eyepiece must be subjected to is equivalent to the additional optical path length introduced by the offset eliminating flange 70, capture cowling 75, adapter coupling 160 and replacement cameral 40 relative to the optical path length to the film plane 22 in the original film camera 20.

The upgrade process continues with the step of attaching a replacement camera to a camera adapter coupling. FIG. 4 shows that a camera adapter coupling 160 effects a mechanical transition from the replacement camera 20 to the quick-release mechanism comprising the offset eliminating flange 70 and capture cowling 75.

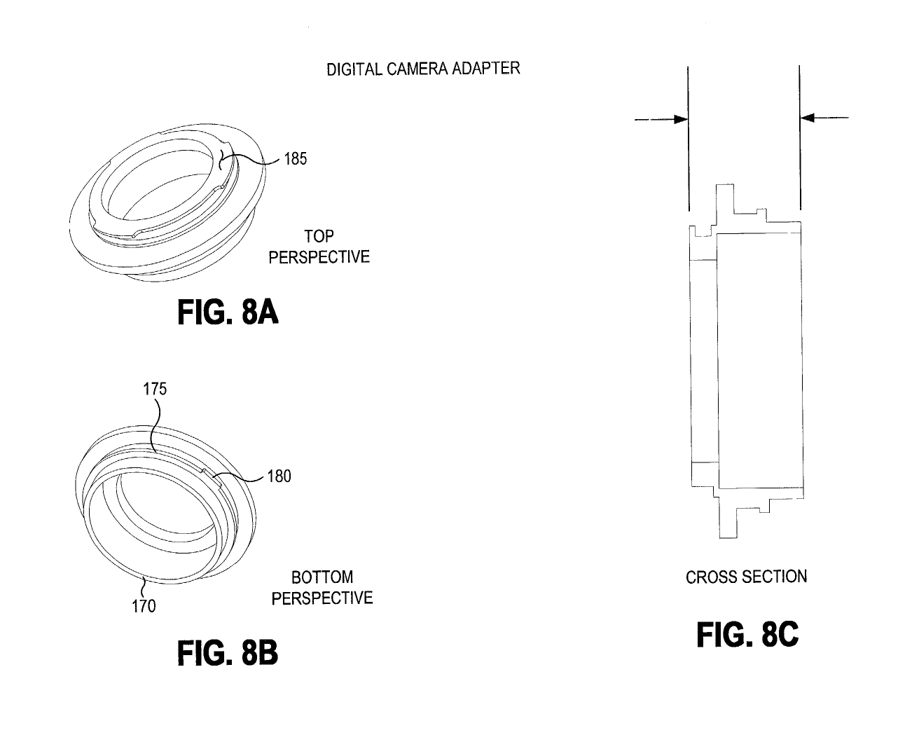

FIGS. 8A through 8C are pictorial representations of one example embodiment of a camera adapter coupling. The camera adapter coupling 160 comprises two ends. One end comprises a standard lens mount that is mimics a camera lens. The opposing end comprises a quick-release coupling that is compatible with the quick-release receptacle formed by the offset eliminating flange 70 and the capture cowling 75.

FIG. 8A depicts the quick-release coupling end of the camera adapter coupling 160. The adapter 160 comprises a first face 165. Protruding from this first face is a tube 170. The adapter 160 further comprises a ridge 175 that extends outward from the tube 170. The ridge 175 further comprises a plurality of splines 180. These splines 180 are used to hold the adapter 160 fast against the offset eliminating mounting flange 70 by the capture cowling 75 as it is tightened onto the flange. Although not shown in the figures, the adapter 160 and the mounting flange 70 may further comprise a pin and lock key mechanism that precludes the adapter from rotating when the cowling 75 is tightened.

FIG. 8B depicts the lens emulation end of the camera adapter 160. As can be inferred from the figure, an industry standard lens mount (lens side) is incorporated into the adapter 160. In one example embodiment, a Nikon F type lens mount 185 is used. Other lens mount types may be used as appropriate. The lens emulation end of the camera adapter 160 is inserted into a replacement camera in lieu of a lens. Once the adapter 160 is installed onto a camera, the adapter is mated with the quick-release coupling attached to the optical assemblage 10.

The overall length of the camera adapter 160 is determined by changing the length of the tube 170 and the position of the ridge 175 relative to said first face 165. The design length is set to be substantially equivalent to the longer of some arbitrary minimum or the amount of displacement that the eyepiece 15 must incur in order to eliminate interference with the body of a replacement camera 40. The arbitrary minimum is selected according to the need to maintain the existing optical path length while effecting the mechanical interface of the replacement camera 40 to the optical assemblage 10.

FIG. 4 further depicts that a compensating lens 155 may be introduced into the optical path of the optical assemblage 10. The next step in upgrading an imaging instrument provides for introducing a compensating lens 155 and possibly a mounting fixture for that compensating lens 155. Again, the mounting fixture for the compensating lens 155 may be designed in accordance with the needs of any given optical assemblage 10 used in any particular imaging system. In some cases, the compensating lens may be glued onto an existing framework. In other instruments, a special fixture for the compensating lens may be needed.

The actual compensating lens may be selected based on the changes introduced into the optical path length. These changes include, but are not limited to those associated with the enlargement of the subject matter onto a larger capture plane. In the present invention, the subject matter is not offset from the center of the image plane 42 and hence it may be enlarged to exploit the entire useable resolution of a replacement camera. The step of selecting a lens may further be predicated on the change of position of the replacement image plane 42 relative to the original image plane 22.

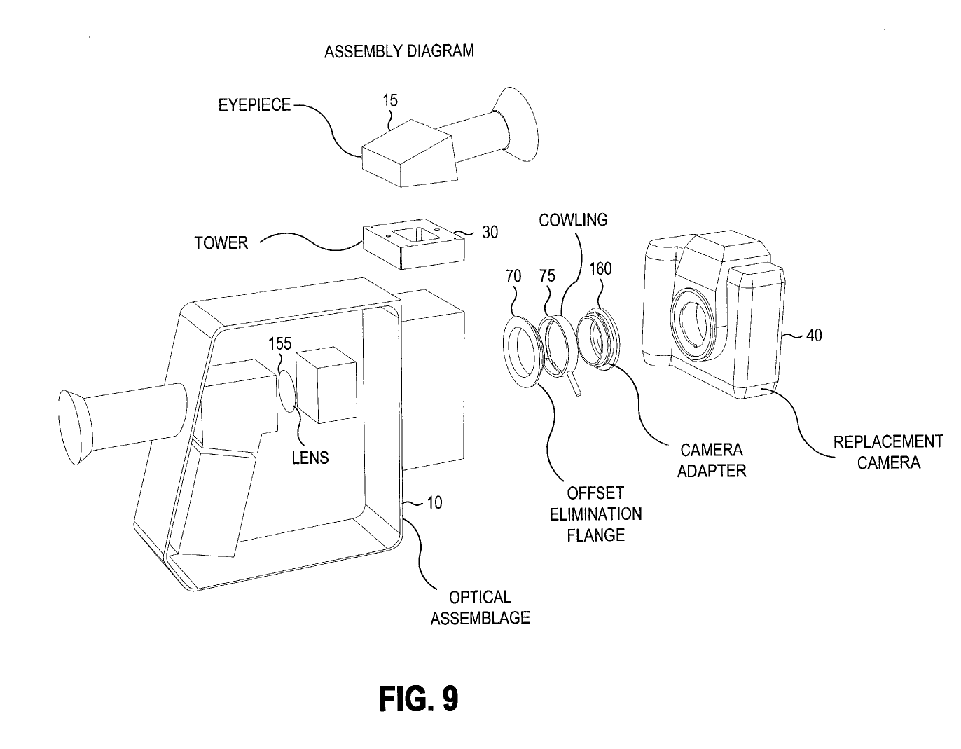

FIG. 9 is a pictorial diagram that depicts the one possible arrangement of the hardware elements of an upgrade kit according to the present invention. The present invention, in addition to the method described herein, further comprises a hardware upgrade kit. The hardware upgrade kit comprises a quick-release receptacle. The quick-release receptacle may comprise either an offset eliminating flange 70 or a non-offset eliminating flange together with a capture cowling 75 according to the descriptions set forth herein. The hardware upgrade kit may further comprise a camera adapter 160 according to the descriptions set forth herein. The hardware upgrade kit may further comprise a digital camera 40. The hardware upgrade may further comprise an eyepiece tower 30 according to the descriptions set forth herein. The hardware upgrade may further comprise a compensating lens selected in accordance with the descriptions set forth herein.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternatives are described herein.

We claim:

1. A method for upgrading an imaging system comprising the steps of:
removing an original camera attachment means from an imaging instrument comprising an optical path wherein the optical path comprises a first subject matter starting point and an original image plane ending point;
attaching a quick-release receptacle to the imaging instrument;
affixing a replacement camera comprising a replacement image plane and a lens mount to a camera adapter coupling wherein the camera adapter coupling comprises a quick-release coupling end and a lens emulating flange opposing the quick-release coupling end and wherein the camera is affixed to the camera adapter coupling by mating the lens emulating flange with the lens mount; and
mating the quick release coupling end of the camera adapter coupling to the quick-release receptacle.

2. The method of claim 1 wherein the camera is a digital camera.

3. The method of claim 1 further comprising the steps of:
inserting a compensating lens into the optical path of the imaging instrument if a compensating lens is required to focus an image onto the replacement image plane or if enlargement of a subject matter image striking the replacement image plane is desired.

4. The method of claim 1 wherein the length of the camera adapter coupling is adjusted to displace the replacement image plane relative to the original image plane in order to enlarge a subject matter image striking the replacement image plane relative to that same image striking the original image plane.

5. The method of claim 1 wherein the imaging instrument comprises an eyepiece, further comprising the step of displacing the eyepiece in order to preclude physical interference of the eyepiece with the cameral.

6. The method of claim 1 wherein the imaging instrument comprises an eyepiece, further comprising the step of displacing the eyepiece in order to compensate for variation in the optical path resulting from displacement of the replacement image plane relative to the original image plane.

7. The method of claim 1 wherein the quick-release receptacle comprises an offset-eliminating flange and a capture cowling.

8. The method of claim 1 wherein the quick-release receptacle comprises an non-offset-eliminating flange and a capture cowling.

9. An upgrade kit for imaging systems comprising:
quick-release receptacle that mounts on an optical assemblage and accepts a quick-release coupling wherein the optical assemblage focuses an image onto an original image plane; and
camera adapter coupling comprising a first end being a quick-release coupling and a second end being a lens-emulating flange and wherein the quick-release coupling mates with the quick-release receptacle.

10. The upgrade kit of claim 9 further comprising a camera.

11. The upgrade kit of claim 10 wherein the camera is a digital camera.

12. The upgrade kit of claim 9 further comprising a compensating lens that adjust the focal length of the optical assemblage so as to focus an image on to a replacement image plane comprising a camera that may be mounted on the lens-emulating flange.

13. The upgrade kit of claim 9 further comprising a compensating lens that enlarges images focused by the optical assemblage on to a replacement image plane comprising a camera that may be mounted on the lens-emulating flange.

14. The upgrade kit of claim 9 wherein the length of the camera adapter coupling is adjusted to displace a replacement image plane comprising a camera that may be mounted onto the lens-emulating flange relative to the original image plane in order to enlarge an image focused by the optical assemblage onto the original image plane.

15. The upgrade kit of claim 9 wherein the optical assemblage comprises an eyepiece mount for accepting an eyepiece and further comprising an eyepiece tower that displaces the mounting position of an eyepiece so as to preclude physical interference of the eyepiece with a camera that may be mounted onto the lens-emulating flange.

16. The upgrade kit of claim 9 wherein the optical assemblage comprises an eyepiece mount for accepting an eyepiece and further comprising an eyepiece tower that displaces the mounting position of an eyepiece in order to compensate for displacement of the a digital image plane comprising a camera that may be mounted onto the lens-emulating flange relative to the original image plane.
